(19) United States
(12) Patent Application Publication
(10) Pub. No.: US 2014/0080494 A1
(43) Pub. Date: Mar. 20, 2014

(54) DIRECT COMMUNICATION METHOD OF TERMINAL, METHOD OF CONTROLLING D2D COMMUNICATION, AND TERMINAL DEVICE

(71) Applicant: Electronics and Telecommunications Research Institute, Daejeon (KR)

(72) Inventors: Soon Yong LIM, Daejeon (KR); Mi Jeong YANG, Daejeon (KR)

(73) Assignee: Electronics and Telecommunications Research Institute, Daejeon (KR)

(21) Appl. No.: 14/026,601

(22) Filed: Sep. 13, 2013

(30) Foreign Application Priority Data
Sep. 14, 2012 (KR) 10-2012-0102457

(51) Int. Cl. H04W 72/04

(52) U.S. Cl. CPC H04W 72/042
USPC 455/450

(57) ABSTRACT

Provided are a direct communication method of a terminal, a method of controlling device-to-device (D2D) communication, and a terminal device. The direct communication method of a terminal includes receiving downlink control information (DCI) from an evolved node base-station (eNB), extracting D2D transmission (Tx) or reception (Rx) grant information including a D2D pairing identity (ID) given to the terminal according to each D2D pair from the DCI, and performing data transmission or reception with a counterpart terminal according to Tx or Rx conditions set according to the D2D pairing ID.

### CLAIM FOR PRIORITY

This application claims priority to Korean Patent Application No. 2012-0102457 filed on Sep. 14, 2012 in the Korean Intellectual Property Office (KIPO), the entire contents of which are hereby incorporated by reference.

### BACKGROUND

1. Technical Field

Example embodiments of the present invention relate in general to device-to-device (D2D) communication based on a cellular network, and more particularly, to a direct communication method of a terminal, a method of controlling D2D communication, and a terminal device.

2. Related Art

As a method for satisfying demands of users by improving performance of a mobile communication network at a low cost, direct communication between mobile communication devices, that is, D2D, has recently been taken into consideration. In general, direct communication is performed between terminals adjacent to each other within a distance of 1 to 2 km in the same cell or adjacent cells of a mobile communication system.

“Device” is a term for a communication terminal included in a cell, and is not functionally different from a terminal. Here, direct communication performed between two devices is referred to as D2D communication.

Like this, D2D communication means a communication method in which two adjacent terminals directly exchange data not via an evolved node base-station (eNB). In other words, according to D2D communication technology, a D2D radio link is established between adjacent devices through a mobile communication radio interface that uses a mobile communication frequency band, and then data is exchanged between the devices through the D2D radio link not via an eNB.

Such D2D communication technology has a variety of advantages. While existing technologies such as wireless fidelity (WiFi) direct, Bluetooth, and Zigbee can only support communication between devices within a distance of hundreds of meters, the D2D communication technology allows direct communication between devices within a distance of 1 to 2 km on the basis of a medium/long range transmission (Tx) capability provided by a mobile communication radio interface.

In addition, since communication between adjacent devices is not performed via a network, a load of the network can be reduced. Also, when adjacent devices located in a cell boundary region communicate with each other via an eNB, low-speed data Tx is allowed. On the other hand, when adjacent devices perform direct communication, high-speed data Tx is allowed due to an obviously improved signal environment between the devices, and thus users can be provided with service of improved performance.

When such D2D communication is controlled on the basis of cellular mobile communication, an eNB handles scheduling between two devices. In other words, by transferring Tx control to a transmitting device and reception (Rx) control to a receiving device, Tx resources and a Tx method of the transmitting device are controlled to be the same as Rx resources and an Rx method of the receiving device.

In existing mobile communication, scheduling information for communication between an eNB and a terminal is transmitted using downlink control information (DCI), but in D2D communication in which data is exchanged between terminals, the existing method cannot be used as it is.

### SUMMARY

Accordingly, example embodiments of the present invention are provided to substantially obviate one or more problems due to limitations and disadvantages of the related art.

Example embodiments of the present invention provide an effective direct communication method of a terminal by improving downlink control information (DCI).

Example embodiments of the present invention also provide a method of controlling device-to-device (D2D) communication.

Example embodiments of the present invention also provide a terminal device that communicates with a counterpart terminal using such a direct communication method.

Example embodiments of the present invention also provide an apparatus for controlling D2D communication.

In some example embodiments, a direct communication method of a terminal includes: receiving DCI from an evolved node base-station (eNB); extracting D2D transmission (Tx) or reception (Rx) grant information including a D2D pairing identity (ID) given to the terminal according to each D2D pair from the DCI; and performing data transmission or reception with a counterpart terminal according to Tx or Rx conditions set according to the D2D pairing ID.

Performing the data transmission or reception with the counterpart terminal may include: determining a Tx buffer according to the D2D pairing ID given by the eNB; and determining at least one Tx parameter necessary to transmit D2D data to the counterpart terminal according to the D2D pairing ID given by the eNB.

Performing the data transmission or reception with the counterpart terminal may further include transmitting the D2D data to the counterpart terminal using the determined Tx buffer and Tx parameter.

The Tx parameter may include at least one of a Tx power and a Tx timing.

Performing the data transmission or reception with the counterpart terminal may include: determining an Rx buffer according to the D2D pairing ID given by the eNB; and determining at least one Rx parameter necessary to receive D2D data from the counterpart terminal according to the D2D pairing ID given by the eNB.

Performing the data transmission or reception with the counterpart terminal may further include receiving the D2D data from the counterpart terminal using the determined Rx buffer and Rx parameter, and processing the received D2D data.

The Rx parameter may include at least one of an Rx timing and an Rx scrambling.

In other example embodiments, a method of controlling D2D communication includes: giving D2D pairing IDs to at least two terminals constituting a D2D pair according to each D2D pair; including the given D2D pairing IDs and D2D Tx and Rx grant information on the corresponding terminals in DCI; and transmitting the DCI to the at least two terminals.

The DCI may be transmitted through a downlink (DL) control channel.

In other example embodiments, a terminal device includes: a D2D controller configured to extract D2D Tx or Rx grant information including a D2D pairing ID given to the terminal device according to each D2D pair from DCI received from an eNB, and set Tx or Rx conditions according to the D2D pairing ID.

The terminal device may further include: a Tx buffer set according to the D2D pairing ID given by the eNB; and a Tx parameter storage configured to store a Tx parameter set according to the D2D pairing ID given by the eNB.

The terminal device may further include a transmitter configured to transmit D2D data to a counterpart terminal using the set Tx buffer and Tx parameter.

The terminal device may further include: an Rx buffer determined according to the D2D pairing ID given by the eNB; and an Rx parameter storage configured to store at least one Rx parameter determined according to the D2D pairing ID given by the eNB.

The terminal device may further include a receiver configured to receive D2D data from a counterpart terminal using the determined Rx buffer.

In other example embodiments, an apparatus for controlling D2D communication includes: a radio resource allocator configured to give a D2D pairing ID to a D2D pair consisting of at least two terminals, and include the given D2D pairing ID and D2D Tx and Rx grant information on the corresponding D2D pair in DCI; and a radio transceiver configured to transmit the DCI to the at least two terminals.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of device-to-device (D2D) communication;

FIG. 2 illustrates the concept of a D2D pair and operational flow between an evolved node base-station (eNB) and at least one terminal according to D2D communication scheduling of the eNB;

FIG. 3 is a conceptual diagram of a method of giving D2D pairing identities (IDs) according to an example embodiment of the present invention;

FIG. 4 is an operational flowchart between an eNB and terminals that use a D2D pairing ID according to an example embodiment of the present invention;

FIG. 5 is a diagram showing constitutions of devices that perform a scheduling operation according to an example embodiment of the present invention;

FIG. 6 is a flowchart illustrating a direct communication method of a terminal according to an example embodiment of the present invention;

FIG. 7 is a block diagram of an eNB that controls D2D communication according to an example embodiment of the present invention; and

FIG. 8 is a flowchart illustrating a method of controlling D2D communication according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, and also portable units or terminals having a combination of such functions, but are not limited to these.

The term “evolved node base-station (eNB)” used herein generally denotes a fixed or moving point that communicates with a terminal, and may be a common name for base station, Node-B, base transceiver system (BTS), access point, relay, femto-cell, and so on.

Also, Long Term Evolution (LTE) will be used to represent LTE and LTE-Advanced.

Hereinafter, example embodiments of the present invention will be described in detail with reference to the accompanying drawings. To aid in understanding the present invention, like numbers refer to like elements throughout the description of the figures, and the description of the same component will not be reiterated.

The present invention proposes a detailed method of improving downlink control information (DCI) and a detailed scheduling method for controlling device-to-device (D2D) communication in a cellular-based mobile communication system.

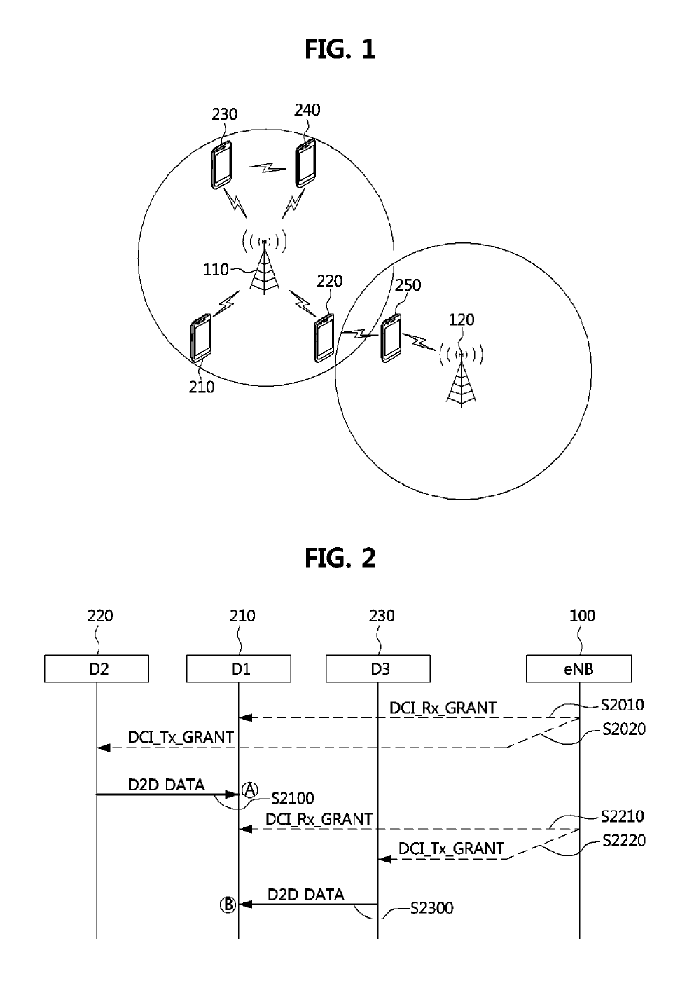

FIG. 1 is a conceptual diagram of D2D communication.

Referring to FIG. 1, a cellular communication network includes a first eNB 110 and a second eNB 120.

While a first device 210 and a second device 220 belonging to a cell served by the first eNB 110 perform communication through general access links based on the first eNB 110, a third device 230 and a fourth device 240 directly perform mutual data transmission (Tx) and reception (Rx) not via an eNB despite belonging to the first eNB 110.

Such D2D communication can be efficiently used in several examples. For example, D2D communication may be applied to a local media server, etc. that provides a large amount of data to attendees of a concert, and so on.

Referring back to FIG. 1, it is possible to know that a D2D link can be established between devices having different cells as serving cells as well as devices having the same cell as a serving cell. In other words, in FIG. 1, the second device 220 belonging to the first eNB 110 performs D2D communication with a fifth device 250 belonging to the second eNB 120.

Such D2D communication includes a centralized-control D2D communication method and a distributed-control D2D communication method.

In the centralized-control D2D communication method, a device intending to communicate with another device requests a central node (an eNB in a cellular network) that performs control to establish a link, and the central node allocates radio resources for D2D communication between the two devices to allow communication between the devices when the devices are adjacent to each other.

Here, the central node manages almost all operations of the devices, and the radio resources allocated for a cellular link or another D2D link may be reused for the D2D communication.

Meanwhile, in the distributed-control D2D communication method, a device establishes a link using a distributed control scheme through direct signal exchange between devices without depending on one central control node, and directly exchanges data with an adjacent device using the link.

A group communication method according to an example embodiment of the present invention can be more appropriately applied to the centralized control method than the distributed control method.

FIG. 2 illustrates the concept of a D2D pair and operational flow between an eNB and at least one terminal according to D2D communication scheduling of the eNB.

FIG. 2 illustrates a case in which D2D communication is performed between D1 and D2 and between D1 and D3, and the D2D relationships between D1 and D2 and between D1 and D3 are referred to as pairs.

A difference between D2D communication and existing cellular communication is that, while there is one one-to-one communication relationship between an eNB and the corresponding terminal in existing cellular communication, there may be several one-to-one communication relationships between a terminal and counterpart terminals in D2D communication.

In FIG. 2, terminal D1 communicates with terminal D3 as well as terminal D2. In this case, terminal D1 has “D1-D2 pair” and “D1-D3 pair.” Terminal D2 has “D2-D1 pair,” and terminal D3 has “D3-D1 pair.” DCI_Tx_Grant denotes Tx control, and DCI_Rx_Grant denotes Rx control.

In connection with this, in an existing LTE or LTE-Advanced system, an eNB performs data Tx and Rx scheduling for a device using DCI in a physical downlink control channel (PDCCH).

DCI of LTE only controls downlink (DL) or uplink (UL) scheduling between a terminal and an eNB. In other words, DCI of LTE has control information types of UL grant and DL assignment, and a terminal can directly check whether DCI is for UL Tx or DL Tx. However, D2D communication is not performed in the form of a DL or a UL, and in the present invention, DCI is configured to indicate D2D Tx control or D2D Rx control

In the scheduling method illustrated in FIG. 2, an eNB 100 transmits D2D Tx and Rx grants to a pair of terminal D1 210 and terminal D2 220. Specifically, the eNB 100 transmits the D2D Rx grant to terminal D1 210 (S2010), and the D2D Tx grant to terminal D2 220 (S2020). At this time, the D2D Tx grant and the D2D Rx grant are included in DCI and transmitted.

Terminal D2 220 receiving the Tx grant from the eNB 100 transmits D2D data to D1 210 that is the counterpart terminal (S2100).

Meanwhile, the eNB 100 transmits a D2D Rx grant to terminal D1 210 in another pair of terminal D1 210 and terminal D3 230 (S2210), and a D2D Tx grant to terminal D3 230 (S2220). Terminal D3 230 receiving the Tx grant from the eNB 100 transmits D2D data to D1 210 that is the counterpart terminal (S2300).

In connection with this, terminal D1 210 that may receive D2D data from terminal D2 and terminal D3 needs to know from which terminals the D2D data received at time points A and B has been transmitted.

In the LTE terminal-eNB relationship, when an eNB performs Rx, a terminal performing UL Tx does not need to indicate which terminal the terminal itself is because the eNB performs scheduling. However, in D2D communication, a receiving device should know a transmitting device to select an Rx entity corresponding to the transmitting device. In addition, the receiving device should know a factor used to perform scrambling by the transmitting device. In LTE, a radio network temporary indicator (RNTI) is used as this factor.

As described above, in D2D communication, a receiving device should know where data is received from. To this end, in example embodiments of the present invention, D2D pairing temporary identities (DPTIs) are given to respective terminals constituting a D2D pair.

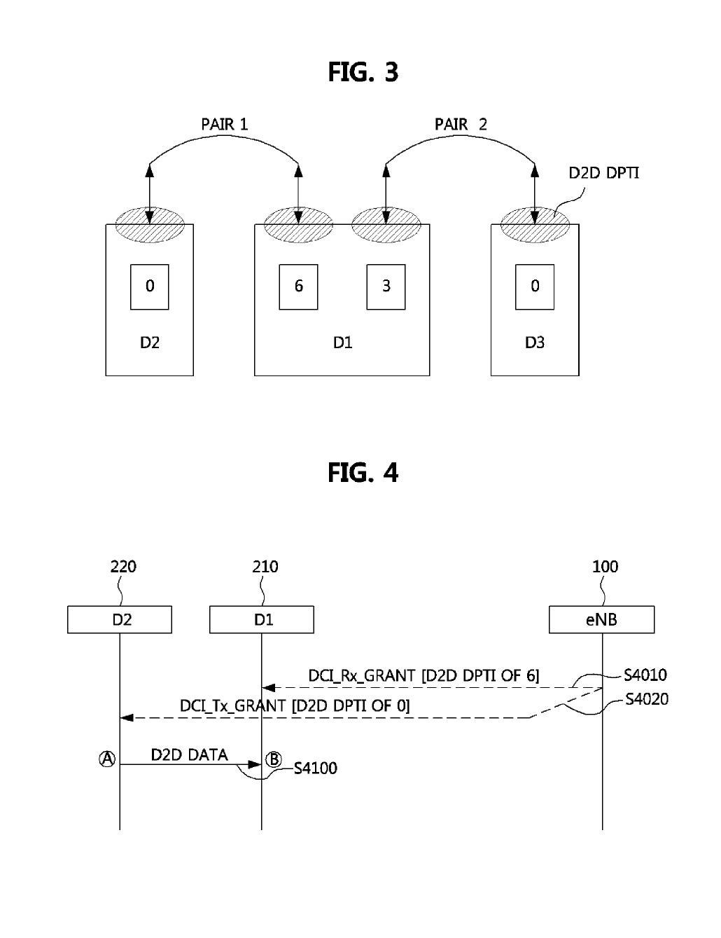

FIG. 3 is a conceptual diagram of a method of giving D2D pairing IDs according to an example embodiment of the present invention.

A D2D pairing ID according to an example embodiment of the present invention is a unique ID given to each terminal constituting a D2D pair, and is indicated as a DPTI in FIG. 3.

In FIG. 3, there are “pair 1” of D1 and D2 and “pair 2” of D1 and D3.

FIG. 3 shows a case in which a DPTI of 0 is given to “D2-D1 pair” of D2, a DPTI of 6 is given to “D1-D2 pair” of D1, a DPTI of 3 is given to “D1-D3 pair” of D1, and a DPTI 0 is given to “D3-D1 pair” of D3. In other words, terminal D1 has its ID of 6 for “D1-D2 pair,” and its ID of 3 for “D1-D3 pair.” Like this, one terminal can be included in several D2D pairs, and manages D2D data Tx and Rx using unique temporary IDs given to the terminal itself according to the respective D2D pairs.

The assigned DPTIs are signaled to the respective devices when an eNB forms the D2D pairs.

Transmitting devices such as D2 and D3 adjust a Tx power according to the length of a D2D path. In the example embodiment of FIG. 3, a high Tx power needs to be used when the distance between D2 and D1 is long, and a low Tx power needs to be used when the distance between D3 and D1 is short. In this way, a transmitting device may operate according to a D2D pair path in which Tx will be performed.

As illustrated in FIG. 3, the method of adaptively processing Tx and Rx according to D2D pairing IDs and constitutions of a device and an eNB that use the processing method are included in the scope of the present invention.

FIG. 4 is an operational flowchart between an eNB and terminals that use a D2D pairing ID according to an example embodiment of the present invention.

Upon scheduling for D2D, an eNB 100 includes D2D pairing IDs in DCI and transmits the DCI. More specifically, the eNB 100 transmits Rx grant control information DCI_Rx_Grant in which a D2D pairing ID (DPTI of 6) given to terminal D1 210 is included to terminal D1 210 (S4010), and transmits Tx grant control information DCI_Tx_Grant in which a D2D pairing ID (DPTI of 0) given to terminal D2 220 is included to terminal D1 220 (S4020).

Each device receiving the DCI performs an operation according to the pair corresponding to a D2D pairing ID.

For D2D communication, (at a time point A) the transmitting device can determine a Tx buffer, a Tx power, and a Tx timing, calculate and use a Tx parameter according to D2D pair characteristics, and so on.

(At a time point B) The receiving device can determine an Rx buffer, an Rx timing, and an Rx scrambling, calculate and use an Rx parameter according to D2D pair characteristics, and so on.

Terminal D2 220 that is the transmitting device transmits D2D data to terminal D1 210 that is the receiving device using the determined Tx buffer and Tx parameter (S4100). At this time, terminal D1 receives and processes the D2D data according to the determined Rx buffer and Rx parameter.

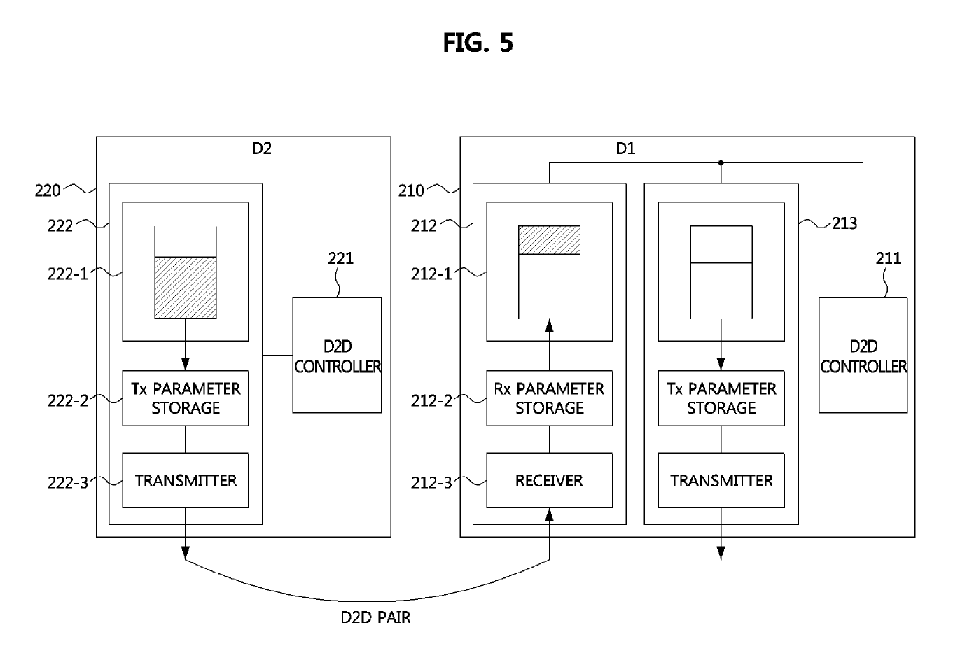

FIG. 5 is a diagram showing constitutions of devices that perform a scheduling operation according to an example embodiment of the present invention.

Terminal D2 220 that is a transmitting device in D2D communication determines a Tx buffer and an operational parameter necessary for Tx according to a D2D pairing ID transmitted through DCI by an eNB, and processes and transmits data according to the determined Tx buffer and operational parameter.

To this end, a D2D controller 221 of terminal D2 configures Tx blocks 222 according to respective D2D pairing IDs, and controls the Tx blocks 222 to process Tx.

Each of the Tx blocks 222 set according to respective D2D pairing IDs may include a Tx buffer 222-1, a Tx parameter storage 222-2, and a transmitter 222-3. The Tx parameter storage 222-2 stores at least one Tx parameter determined by the D2D controller 221. The transmitter 222-3 transmits D2D data processed according to a Tx parameter to terminal D1.

Meanwhile, a D2D controller 211 of terminal D1 210 that is a receiving device determines operational parameters necessary to receive D2D data according to D2D pairing IDs included in DCI received from the eNB, receives D2D data from the transmitting device, and transfers the received D2D data to an appropriate Rx buffer.

Terminal D1 that is a receiving device in the pair of terminal D1 and terminal D2 also includes separate Rx blocks 212 according to the D2D paring IDs. Each of the Rx blocks 212 set according to the respective D2D pairing IDs may include an Rx buffer 212-1, an Rx parameter storage 212-2, and a receiver 212-3. The receiver 212-3 receives the D2D data from terminal D2, and transfers the received D2D data to an Rx buffer 212-1 determined by the D2D controller 211. The Rx parameter storage 212-2 stores at least one Rx parameter determined by the D2D controller 211.

The D2D controller 211 processes D2D data temporarily stored in the Rx buffers 212-1 using Rx parameters set according to the respective D2D pairing IDs.

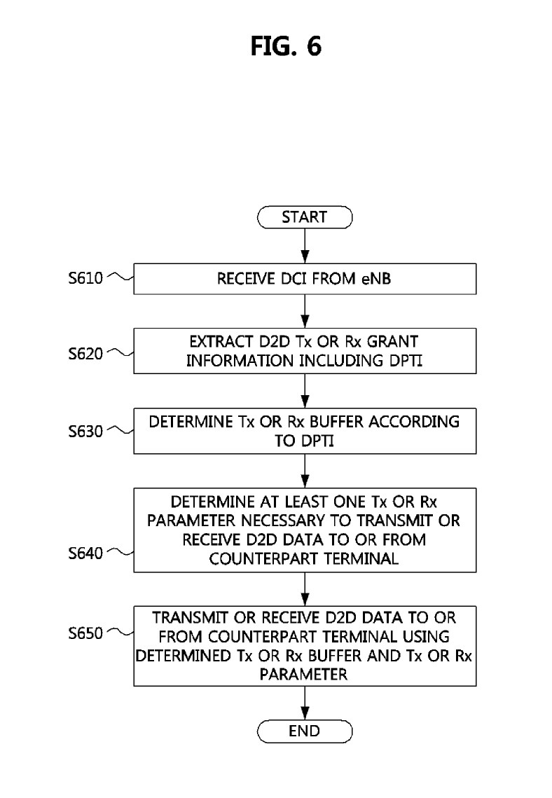

FIG. 6 is a flowchart illustrating a direct communication method of a terminal according to an example embodiment of the present invention.

A device intending to perform D2D communication, that is, a terminal device, receives DCI from an eNB first (S610). From the received DCI, the terminal device extracts D2D Tx and Rx grant information including D2D pairing IDs given to the terminal device itself according to respective D2D pairs (S620).

The terminal device acquires the unique D2D pairing IDs from the D2D Tx and Rx grant information, and determines Tx and Rx buffers according to the DPTIs (S630). In other words, the terminal device determines a Tx buffer or an Rx buffer for a D2D pairing ID given by the eNB according to whether the terminal device itself is a transmitting side or a receiving side of D2D communication.

The terminal device determining a Tx buffer or an Rx buffer also determines at least one Tx or Rx parameter necessary to transmit or receive D2D data to or from a counterpart terminal (S640). When the terminal device is a transmitting side of D2D communication, at least one Tx parameter is determined, and when the terminal device is a receiving side of D2D communication, at least one Rx parameter is determined.

Finally, the terminal device transmits or receives D2D data to or from the counterpart terminal using the determined Tx or Rx buffer and Tx or Rx parameter (S650).

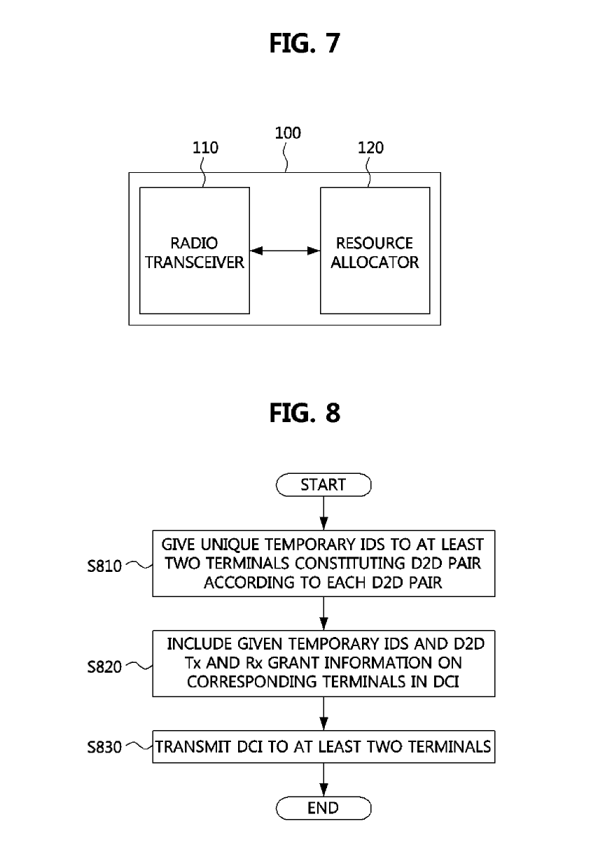

FIG. 7 is a block diagram of a D2D communication control apparatus that controls D2D communication according to an example embodiment of the present invention.

A typical example of the D2D communication control apparatus shown in FIG. 7 may be an eNB.

The D2D communication control apparatus 100 according to an example embodiment of the present invention may include a radio resource allocator 120 and a radio transceiver 110.

The radio resource allocator 120 gives D2D pairing IDs to at least two terminals constituting a D2D pair according to each D2D pair, and includes the given D2D pairing IDs and D2D Tx and Rx grant information on the corresponding terminals in DCI. The radio transceiver 110 transmits the DCI generated in this way to the at least two terminals.

At this time, the DCI is transmitted through a PDCCH.

FIG. 8 is a flowchart illustrating a method of controlling D2D communication according to an example embodiment of the present invention.

A typical subject that performs the method of controlling D2D communication illustrated in FIG. 8 may be an eNB.

An eNB receiving a D2D communication request from a terminal gives D2D pairing IDs to at least two terminals constituting a D2D pair according to each D2D pair (S810).

The eNB includes the given temporary IDs and D2D Tx and Rx grant information on the corresponding terminals in DCI (S820) to configure a DL frame, and transmits the configured DL frame to the at least two terminals. In other words, the eNB transmits the DCI including the D2D Tx and Rx grant information on the D2D pair and the D2D pairing IDs to the terminals (S830). At this time, the DL control information may be transmitted through a PDCCH.

In a D2D communication method and a method of controlling D2D communication as described above, IDs are given for a D2D pair rather than devices, and thereby it is possible to perform appropriate scheduling for a characteristic of D2D communication that one device can establish D2D links with several other devices.

While the example embodiments of the present invention and their advantages have been described in detail, it should be understood that various changes, substitutions and alterations may be made herein without departing from the scope of the invention.

What is claimed is:

1. A direct communication method of a terminal, comprising:
receiving downlink control information (DCI) from an evolved node base-station (eNB);
extracting D2D transmission (Tx) or reception (Rx) grant information including a D2D pairing identity (ID) given to the terminal for each D2D pair from the DCI; and
performing data transmission or reception with a counterpart terminal according to Tx or Rx conditions set according to the D2D pairing ID.

2. The direct communication method of claim 1, wherein performing the data transmission or reception with the counterpart terminal includes:
determining a Tx buffer according to the D2D pairing ID given by the eNB; and
determining at least one Tx parameter necessary to transmit D2D data to the counterpart terminal according to the D2D pairing ID given by the eNB.

3. The direct communication method of claim 2, wherein performing the data transmission or reception with the counterpart terminal further includes transmitting the D2D data to the counterpart terminal using the determined Tx buffer and Tx parameter.

4. The direct communication method of claim 2, wherein the Tx parameter includes at least one of a Tx power and a Tx timing.

5. The direct communication method of claim 1, wherein performing the data transmission or reception with the counterpart terminal includes:
determining an Rx buffer according to the D2D pairing ID given by the eNB; and
determining at least one Rx parameter necessary to receive D2D data from the counterpart terminal according to the D2D pairing ID given by the eNB.

6. The direct communication method of claim 5, wherein performing the data transmission or reception with the counterpart terminal further includes receiving the D2D data from the counterpart terminal using the determined Rx buffer and Rx parameter, and processing the received D2D data.

7. The direct communication method of claim 5, wherein the Rx parameter includes at least one of an Rx timing and an Rx scrambling.

8. A method of controlling device-to-device (D2D) communication, comprising:
giving D2D pairing identities (IDs) to at least two terminals constituting a D2D pair according to each D2D pair;
including the given D2D pairing IDs and D2D transmission (Tx) and reception (Rx) grant information on the corresponding terminals in downlink control information (DCI); and
transmitting the DCI to the at least two terminals.

9. The method of claim 8, wherein the DCI is transmitted through a downlink (DL) control channel.

10. A terminal device, comprising:
a device-to-device (D2D) controller configured to extract D2D transmission (Tx) or reception (Rx) grant information including a D2D pairing identity (ID) given to the terminal device according to each D2D pair from downlink control information (DCI) received from an evolved node base-station (eNB), and set Tx or Rx conditions according to the D2D pairing ID.

11. The terminal device of claim 10, further comprising:
a Tx buffer set according to the D2D pairing ID given by the eNB; and
a Tx parameter storage configured to store a Tx parameter set according to the D2D pairing ID given by the eNB.

12. The terminal device of claim 11, further comprising a transmitter configured to transmit D2D data to a counterpart terminal using the set Tx buffer and Tx parameter.

13. The terminal device of claim 10, further comprising:
an Rx buffer determined according to the D2D pairing ID given by the eNB; and
an Rx parameter storage configured to store at least one Rx parameter determined according to the D2D pairing ID given by the eNB.

14. The terminal device of claim 13, further comprising a receiver configured to receive D2D data from a counterpart terminal using the determined Rx buffer.
